(19) United States
(12) Patent Application Publication
(10) Pub. No.: US 2016/0033376 A1
(43) Pub. Date: Feb. 4, 2016

(54) Apparatus and Process for Producing Patterned, Micron and Nanometer Size Reaction and Mixing Zones for Fluids Deposited on Smooth, Rough and Porous Surfaces and Applications of that Process

(71) Applicant: CARNEGIE MELLON UNIVERSITY, a Pennsylvania Non-Profit Corporation, Pittsburgh, PA (US)

(72) Inventors: Stephen Garoff, Pittsburgh, PA (US); Shelley Lynn Anna, Pittsburgh, PA (US)

(73) Assignee: CARNEGIE MELLON UNIVERSITY, a Pennsylvania Non-Profit Corporation, Pittsburgh, PA (US)

(21) Appl. No.: 14/817,878

(22) Filed: Aug. 4, 2015

Related U.S. Application Data
(63) Continuation of application No. 13/576,075, filed on Jul. 30, 2012, now abandoned.
(60) Provisional application No. 61/337,954, filed on Feb. 15, 2010.

(51) Int. Cl. G01N 1/38

(52) U.S. Cl. CPC G01N 1/38

(57) ABSTRACT

Process for producing patterned, micron and nanometer scale features by reacting or mixing in the small volumes at the intersections of coalescing drops, at the fronts of colliding thin films in front of spreading drops, or in the pore space of a porous medium under the drop. The process can be implemented on smooth, rough or porous surfaces and embodiments include multiplexed, single drop chemical or biochemical sensors and encryption of information of a printed page.

### CROSS-REFERENCE TO RELATED APPLICATIONS

The present invention is a Continuation application of U.S. application Ser. No. 13/576,075 filed on Jul. 30, 2012, which is a national stage filing under 35 U.S.C. §371 of International Application Number PCT/US2011/000288, entitled “APPARATUS AND PROCESS FOR PRODUCING PATTERNED, MICRON AND NANOMETER SIZE REACTION AND MIXING ZONES FOR FLUIDS DEPOSITED ON SMOOTH, ROUGH AND POROUS SURFACES AND APPLICATIONS OF THAT PROCESS” filed on Feb. 15, 2011, which is a Non-provisional application of U.S. Provisional Application No. 61/337,954, titled PROCESS FOR PRODUCING PATTERNED, MICRON AND NANOMETER SIZE REACTION AND MIXING ZONES FOR FLUIDS DEPOSITED ON SMOOTH, ROUGH AND POROUS SURFACES AND APPLICATIONS OF THAT PROCESS, filed on Feb. 15, 2010, all are herein incorporated by reference.

### STATEMENT REGARDING FEDERALLY SPONSORED RESEARCH OR DEVELOPMENT

The invention was made with government support under Federal Grant Numbers NASA 21399.3.2002 by the National Aeronautics and Space Administration. The United States Government has certain rights to the invention.

### FIELD OF THE INVENTION

The invention relates generally to assay testing, and in particular to conducting a series of tests with only one specimen drop.

### BACKGROUND

The present invention discloses a process for patterning micron and nanometer scale zones in which mixing or chemical reactions between two liquids can occur. The process takes advantage of the small volumes at the intersections of coalescing drops, at the fronts of colliding thin films moving ahead of them, or in the pore space of a porous medium under the drop. Current technologies that place droplets on surfaces do not focus on the region between droplets. For example, inkjet printing technology deposits drops on surfaces to create the pixels of an image. In this case, precise control of the intersection zone between drops is not a primary concern. Spray coating technology also deposits drops on surfaces, but here the goal is to uniformly cover the surface so it is desired that the drops are all the same composition, and that they merge quickly to form a uniform film that covers the surface. The key difference in the present invention lies in its ability to (1) deposit drops of different composition next to each other, and then (2) to control the volume and dimensionality in which they meet. By confining the mixing or reaction within an intersection volume that is substantially smaller than the primary drop volume, the ability to produce patterns much smaller than the main drops is achieved. The present invention is capable of confining the mixing or reaction zone to the intersections of the fluid films or in pore spaces filled by the spreading liquids. Using this process, multiple mixing zones can be created on the periphery of a single drop without crosstalk. There are currently no known competing processes.

For some applications, combining the proposed sub-drop patterning method with established processes for writing the primary drops, for example via inkjet printing, the present invention has the potential to become a powerful, scalable manufacturing process for writing nanoscale patterns over large surface areas. The ability to print nanoscale features over large surface areas using an extension of established and relatively low-cost technologies (inkjet printing) would represent a breakthrough in low cost, low temperature printing capabilities. In one embodiment, the present invention will allow encryption of data in a printed page.

In chemical or biochemical sensing applications, this process will allow several chemical analyses to be performed on a single drop of liquid in parallel on a simple surface. This surface is highly nonspecific and so could be used for a wide variety of chemical and biochemical tests without modification, thus allowing for a cheap, robust and reusable process. Another key advantage is the ability to tailor the interaction volume to any given application using the wide variety of material properties of the solvents, solutes, and surfaces as well as various combinations of hydrodynamic and capillary forces.

### BRIEF SUMMARY OF THE INVENTION

The present invention disclosed provides a process for producing patterned, micron and nanometer scale features by reacting or mixing in the small volumes at the intersections of coalescing drops, at the fronts of colliding thin films emerging from spreading drops, or in the pore space of a porous medium under the drop. Embodiments of the present invention include the process being implemented on smooth, rough or porous surfaces. Applications of the process include chemical and biochemical sensors and encryption techniques.

### BRIEF DESCRIPTION OF THE DRAWINGS

FIGS. 1A-D shows four methods of forming intersection volumes: (A) from the meeting of spreading drops; (B) from the meeting of expanding precursing films ahead of static drops; (C) from the meeting of fluid drawn through roughness features of a surface ahead of static drops; and (D) from the meeting of fluid drawn into pore space below static drops;

FIG. 1E illustrates a top view of the interaction zone gap and wettability boundaries of the outer circumferences for embodiments illustrated in FIGS. 1B and 1C;

FIG. 2 illustrates a diagnostic pattern for direct collision of drops with or without wettability boundaries;

FIG. 3 presents a diagnostic pattern which conducts fluid between the central and satellite locations via roughened lines on the surface, strips of porous media attached to the surface or channels formed by wettability boundaries. The mixing zone may be located in these channels or at the edges of either the central or satellite locations;

FIG. 4 is a side view of a sandwiched embodiment of the present invention

FIG. 5 is a top view of the sandwiched embodiment shown in FIG. 4;

FIG. 6 is a flow Chart depicting seven embodiments of the present invention;

FIG. 7A-C are top and side views of open and sandwich embodiment with just one satellite to illustrate relevant dimensions;

FIGS. 8A-C are illustrations of satellite or reagent sizes and positioning about a sample or specimen drop.

### DETAILED DESCRIPTION OF THE INVENTION

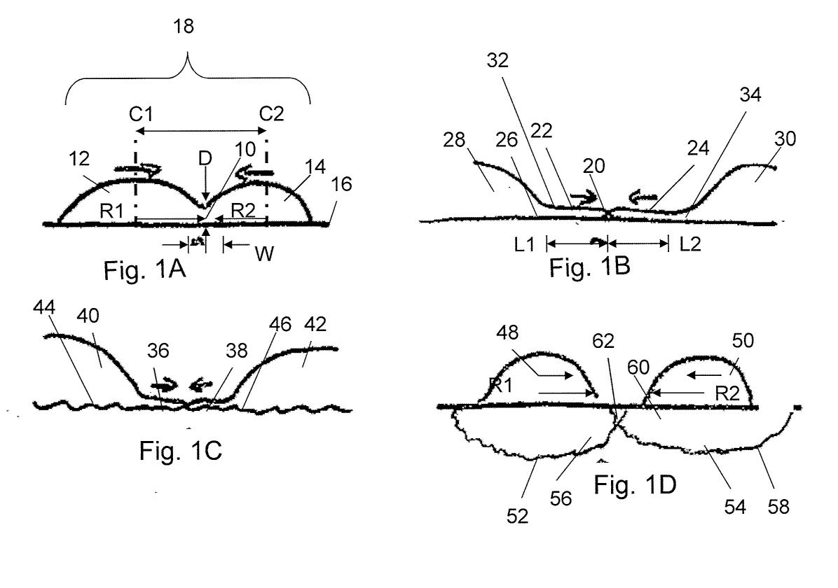

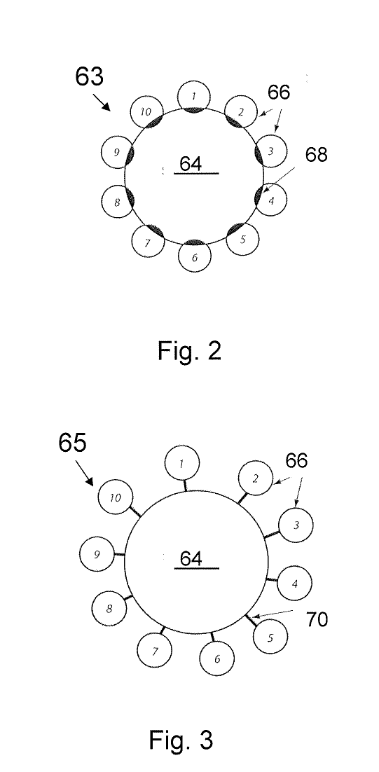

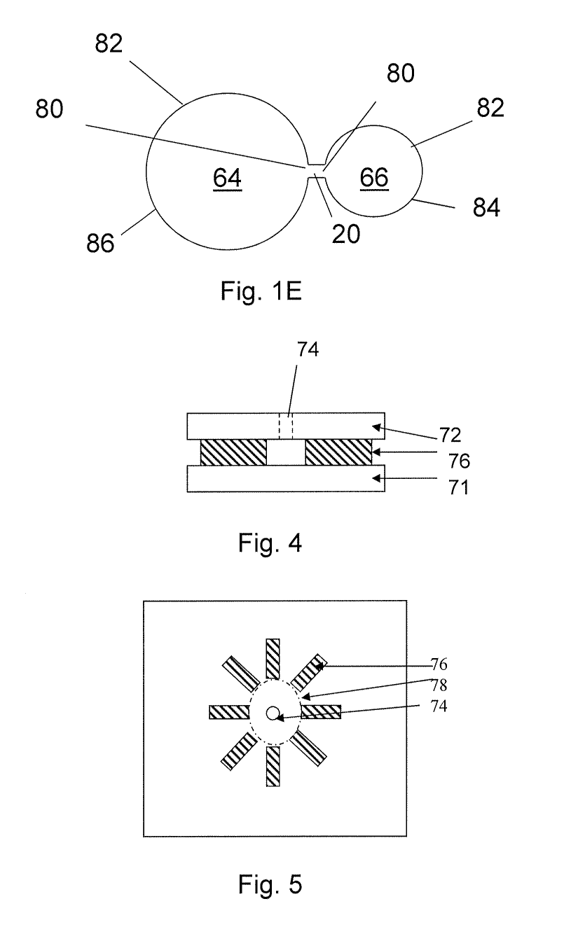

The present invention is a process for patterning micron and nanometer scale zones in which mixing or chemical reactions between two liquids can occur. The process takes advantage of the small volumes at the intersections of coalescing drops, at the fronts of colliding thin films moving ahead of them, or in the pore space of a porous medium under the drop. FIGS. 1A-D shows four possible interaction zones. The interaction volumes so produced are orders of magnitude smaller than the primary drops and range from microns (coalescing drops) to nanometers (precursing films). Some applications may require that the fluids dry and leave the products of the mixing or reaction in a dried state on the surface. Other applications may require observation in the wet state before drying is complete. The present invention will enable deposition of such materials as metals, inks, gels, and nanocrystallites. As described below, using known fluid mechanics, prior knowledge of wetting phenomena, and proper choice of fluids and surfaces, the interaction zone can be designed to have well controlled size and geometry.

The embodiments of the present invention are a function of one or more the following fluid mechanics and wetting phenomena;

A. Viscosity of liquids—Dictated by specimen to be tested and reagent fluids in satellites.

B. Surface tensions of all fluids—Dictated by specimen to be tested and reagents fluids in satellites.

C. Marangoni stresses—Dictated by specimen to be tested and reagents fluids in satellites and any solutes dissolved or suspended in them. Arise from surface tension differences between coalescing drops.

D. Fluid Drop Boundary Condition including fixed contact line position, fixed contact angle, contact angle hysteresis.—Through use of homogeneous surface and/or patterned wettability surface, size of spots for specimen drop and reagent drop/zone (wet or dry) embodiment designed to control drop locations after coalescence and to control the fluid movements during the latter stages of coalescence, contributing to the control of the mixing zones.

E. Contact angles at point of contact between drops—Embodiment designed to impact the fluid movement during early stages of coalescence, contributing to the control of the mixing zones.

F. Central (specimen) drop volume—Specimen drop volume designed to control the mixing zones.

G. Satellite reagent pad size (when used)—Alternative embodiments designed to have reagents impregnated into pads of porous materials and located in the satellite locations. Pad size contributes to the control of the mixing zones.

H. Satellite reagent drop volumes—Alternative embodiments designed to have reagent in form of a drop at satellite locations. Drop size contributes to the control of the mixing zones.

I. Satellite reagent spot size—Alternative embodiments designed to have reagent dried or chemically grafted into spots at the satellite locations. Spot size contributes to the control of the mixing zones.

J. Distance from central drop to satellite pads, spots, or drops—Designed to control the mixing zones.

K. Roughness scale on nonporous control surfaces including separately the scale in a direction along surface, depth into the surface, and anisotropy in the plane of the surface—Designed to control the mixing zones.

L. Porosity and wettability of pore space of porous surface—For embodiments using method in FIG. 1D, designed to control fluid movement approaching coalescence, contributing to the control of the mixing zones; and in embodiment using, method in FIG. 1A, to control removal of fluid after coalescence, contributing to the freezing in of a mixing zone after it is formed.

M. Porosity and wettability of pore space of porous pad in satellite spots—Designed to control the mixing zone.

N. Rate of spreading of central drop (assumes satellite drops are predeposited and stationary when coalescence occurs)—In embodiments using drops in the satellite positions, designed to control fluid movement approaching coalescence, contributing to the control of the mixing zones.

O. Evaporation rates of specimen and/or reagent fluids. Dictated by specimen to be tested and reagents fluids in satellites. Designed to control removal of fluid after coalescence, contributing to the freezing in of a mixing zone after it is formed.

P. Diffusion rates of fluids to be mixed—Dictated by specimen to be tested and reagents fluids in satellites.

Q. Heating the surfaces—Embodiments designed with this feature to impact evaporation rates.

Now turning to FIG. 1A illustrating an interaction or mixing zone 10 created by colliding drops 12, 14. When viscous drops 12, 14 spread on a planar surface 16, the radii R1, R2 grow with time T according to established scaling theories depending on whether capillarity or gravity are more important. Marangoni stresses may also impact these rates. If two spreading drops 12, 14 meet on a planar surface 16, a liquid bridge 10 forms at the intersection region of the drops, the “interaction zone”, with a growing width W1 and depth D2 that are consistent with the primary spreading rate and mass conservation. The volume and width of the intersection region are orders of magnitude smaller than those of the primary drops 12, 14, and the rate of growth of the region is controlled by fluid and surface properties (discussed above). The coalescence dynamics controls the initial geometry of the volume where the mixing or chemical reaction takes place. Interdiffusion of the liquids controls further mixing but on a longer time scale. Removal of the fluid out of the coalesced drop 18—either by evaporation or by drawing solvent into an underlying pore space in the surface—can freeze-in the defined mixing or reaction zone created upon coalescence before further mixing by diffusion and can deposit the mixture or chemical product. With lower viscosity liquids with volatilities similar to water and on surfaces without unusually fast imbibition rates, these three processes have widely differing time scales and can be independently controlled.

Now turning to FIG. 1B to illustrate an interaction zone 20 created by colliding thin films 22, 24 on smooth surfaces 26. Under nearly perfect wetting conditions, a drop 28, 30 spreads rapidly in direction of the arrows and a spreading precursing film 22, 24 moves ahead of the drop edge 32, 34, called the contact line, in some cases. The mixing or reacting zone 20 is now at the intersection of the colliding thin films 22, 24. Precursing films 22, 24 can be as thin as monomolecular or as thick as 10 to 1000 nanometers, thus creating interaction volumes with those length scales. Mixing and reaction will occur in virtually two-dimensional regions thus confining molecules participating in the mixing or reactions and possibly producing new reaction or mixing products. This might be particularly true if the solutes are polymers or nanocrystallites. The drop contact lines usually advance slower than the film grows; but the drop spreads very far and, in equilibrium, covers the thin film. To avoid this, the drop spreading can be limited by a wettability boundary. By making a gap 80 (see FIG. 1E) in that boundary, the thin film will escape and collide with another film, thus allowing us to use this process even in the case of fully wetting fluids. FIG. 1E also illustrates wettability boundary 82 that confines the drops within the outer circumferences 84, 86 of the specimen drop portion 64 and the reagent drop portion 66, respectively, and gap 80.

The films 22, 24 may be produced in three separate ways depending on the materials involved:

a) Films in front of autophobing or autophiling materials: these films contain a monolayer of oriented molecules. They move out in front of the contact line by a diffusive or diffusive-like motion. In the case of the autophobing, the contact line of the drop is arrested by the monolayer so the drop is well defined and the monolayer grows slowly beyond it. In this case, the two fluids would be mixed or react in a monomolecular space with orientation imposed on the mixing or reacting molecules;

b) Films spread across a surface for a completely wetting system. Depending on the materials, this film may be continuous or may be dendritic in structure. The contact line of the drop follows the film but moves more slowly. As in paragraph 0039, the method of a wettability boundary with a gap may be used to arrest the drop spreading and allow the mixing or reaction zone to be only in the spreading film The films of liquids are thick enough (order of 10 nm) to move both solvent and solute. In the case of a dendritic film structure, the mixing zones with be extremely complex, forming wherever dendrites happen to meet.

c) In slowly growing fluid films 22, 24 in front of fully wetting contact lines 32, 34, the films 22, 24 grow due to disjoining pressure, with the growth rate of their length L1, L2 inhibited by a “friction” with the surface 26. The films 22, 24 range from molecular to submicron in thickness but can grow to millimeter lengths. The drops 28, 30 are trying to reach zero contact angle, so eventually it will cover the thin film unless arrested. It is possible to use the barrier with the gap to arrest the drop spreading and allow only the films to meet. These films are likely thick enough to carry both solvent and solute to the mixing zone where the films meet.

Now turning to FIG. 1C illustrating an interaction zone created by colliding fluids moving in the designed roughness features of a surface. Roughness features 44 on the surface 46 promote precursing films 36, 38 ahead of the spreading drops 40, 42 due to capillary action. In this case, the films 36, 38 are on the scale of the roughness features. The capillary pressure in the roughness features will draw the fluid ahead of the spreading drops but the drops are now spreading virtually over their own fluid. One embodiment can include wettability boundaries with gaps 80 (see FIG. 1E).

Now turning to FIG. 1D illustrating an interaction zone created in pore space of porous surfaces. Fluid 52, 54 are pulled out of each drop 48, 50 by capillary pressure into the pore space 56, 58 beneath spreading drops 48, 50 on porous surfaces 60. The mixing or reaction zone 62 will be formed where the fluid 52, 54 fronts in the pore space 56, 58 meet; since at the pore level, flow is stopped when the fluid in a pore from one drop meets the fluid from the other drop in an adjacent pore. The scale of the interaction zone 62 will be the pore size. The drops 48, 50 may be spreading toward each other in the direction of the arrows but may be stopped from touching by either the wettability of the surface or by imbibing fluid into the pore space rapidly enough that all fluid is removed from the drops 48, 50 before they touch.

The process described above will enable the development of a number of applications. These include: encryption of patterns in a printed page: printing information at the intersection of drops forming the main printed pattern—described further below; multiplexed analysis of single drops of material for forensic, chemical or biochemical applications; patterning micron or nanometer size conductors on a surface at the intersections of series of drops from an inkjet type device for example using Tollins reaction to produce silver; producing small batteries connected on demand by depositing a drop of electrolyte and completing a circuit between printed anode and cathode; patterning a gel into micron and nanometer barriers on substrates for display technologies, e.g., forming patterned barriers for pixel separation using, Ca⁺² ions and alginate ions in the separate drops; and patterning micron and nanometer bioscaffolds using fibrin and fibrinogen in the separate drops.

The ability to print nanometer features over large surface areas would enable encryption of patterns in a printed page, i.e., printing information at the intersection of drops or in the pore space between the main drops forming the main printed pattern. One embodiment of the present invention involves producing, at the intersection zone, the color that is the mixture of colors arising from the colors in the two original drops. Another embodiment allows for the printing of a nanometer pattern by inducing reactions in the intersection zone. Thus, precipitates such as AgCl could be deposited in the patterned interaction volumes by incorporating Ag⁺ and Cl⁻ ions in the two separate drops. Other reaction pairs producing a precipitate are possible. Readout of even a faint encryption would be made possible by recognition of a predesigned pattern. In this embodiment, scale up would be enabled using inkjet printing technologies.

Now turning to FIG. 2 illustrating one embodiment 63 of the present invention being a chemical or biochemical sensor where a single drop of fluid is subjected to multiple chemical analyses in parallel. The test or specimen drop 64 is placed in the central spot and the reagent drops 66 (10 reagent drops are illustrated, but the invention is not to be limited any specific number of reagent drops). The drops may be freely spreading or confined by wettability patterns. The reagent spots 66 may contain drops of reagent or porous media impregnated with reagent or reagent chemically grafted to the surfaces in the spots. By confining the reaction or mixing zone 68 between each reagent drop 66 and the central specimen drop 64 and designing the fluid flow so that there is no or minimal flow into the central drop, all tests can be run in parallel without crosstalk between tests.

Now turning to FIG. 3 illustrating another embodiment 65 of the present invention where direct communication between drops does not provide sufficient isolation between tests. This embodiment shows bridges 70 between the specimen drop 64 and reagent drops pads or spots 66 are created so direct contact between the drops is prevented and mixing or reaction occurs in the bridges or at the entrance to the satellite positions. The bridges 70 may be smooth or roughened wettable surfaces or porous media. The bridges 70 may also be non-wettable with the ability to photolytically etch the bridge, make it wettable, and open that channel of communication on demand.

Many potential readouts of the tests are possible. These may be colorimetric in nature. One embodiment includes a specific color being produced when the reaction or mixing occurs. Another embodiment includes gold colloids in each of the reagent drops, each derivatized with specific biomarkers. A positive test causes either a shift in the plasmon resonance or aggregation of the colloid and the attendant colorimetric changes in the interaction area. Another embodiment may utilize immunoassays.

Three advantages of this chemical sensor design are: 1) the design, particularly when wettability boundaries are used and made from perfluorinated silane monolayers on glass, is completely general and could be employed for a wide variety of tests without modification. Thus, this surface could be used as a test bed in forensic, laboratory chemical analysis, chemical or biochemical warfare, and medical applications; 2) the test surface would be cheap to produce and 3) these surfaces could be employed as a low-cost medical diagnostic tool for use in underdeveloped areas where ease of use is critical.

Some embodiments of the present invention are prepared using homogeneously wetted flat surfaces as follows.

One embodiment of the present invention cleans a substrate surface (such as glass) with any one of a number of typical acid cleaning procedures. A clean high energy surface such as glass will produce a surface with a very low static contact angle against water or a hydrocarbon fluid. The surface will have some contact angle hysteresis. Some fluids containing specific classes of surface active components may show higher contact angles.

Another embodiment of the present invention cleans a polymer (e.g., PMMA, polycarbonate) surface with organic solvents that cannot dissolve or soften the polymer. These surfaces typically have higher contact angles than glass and may produce a higher hysteresis. The wettability conditions will slowly vary with time. For example, Polydimethylsiloxane gives a surface with high contact angles and particularly low hysteresis. Any of these polymer surfaces can be made as thin films on top of glass or in thicker, self-supporting plates. Both the film and plate surfaces show the same wetting behavior.

Yet another embodiment of the present invention takes the clean glass and covalently grafts a monolayer of surfactant-like molecules on it that control the wettability. The static contact angle and contact angle hysteresis can be tuned by selecting the correct surfactant chemistry or using a mixture of such molecules. There is a similar set of molecules that can be bound to gold, silver or copper surfaces (including thin films of gold, silver or copper deposited on glass) that gives similar, if not better control, of the contact angles. One embodiment of the present invention uses Aquapel® to achieve desired wettability characteristics. Exposing any of these surfaces to UV light containing both 184 nm and 254 nm wavelength will cause them to become more wettable, usually with higher hysteresis. The time of exposure controls the contact angle on the exposed region—the longer the time, the more wettable the surface.

Some embodiments of the present invention are prepared using patterned wettability flat surfaces as follows.

One embodiment of the present invention starts with clean glass and covalently graft a monolayer of surfactant molecules on it that control the wettability as discussed above. A metal mask having the desired patterned for drop fluid control (see for example FIGS. 2 and 3) is placed tightly against the clean glass and exposed the UV light as mentioned above. The exposed portion will become more wettable while the masked region maintains its original wettability. This produces boundaries that can pin the contact lines of spreading drops on a surface or directionally guide the spreading. Using this UV exposure to completely burn organic contaminates from a surface is common practice. Wettability patterns can be produced on non-porous surfaces and porous surface, including papers, using the above method.

One embodiment of the present invention includes very small (in height) microfabricated patterns on a surface to produce a surface with controlled contact line positions. The prepared features are too small in height and too wide in lateral dimension to guide fluid movement by capillarity (such as used in the roughened surface designs), but fluid movement is guided by contact line pinning and location.

Some embodiments of the present invention have a single substrate structure (open geometry) or a two substrate structure (closed geometry). The open surface geometry can be on a homogeneous surface such that fluids move due to equilibration of drop shapes to their equilibrium configuration or can be on a surface that controls the fluid movement and location by wettability boundaries such as illustrated in FIGS. 2 and 3. The closed geometry includes a bottom substrate 71 with a top plate 72 (as shown in FIG. 4) to form a “sandwich” such that fluid motion induced by capillarity moves fluids in the gap between the plates. The top plate 72 includes feeder hole 74 sized to receive the specimen drop. Either surface can be a homogeneous surface such that fluids move due to equilibration of drop shapes to their equilibrium configuration or can be on a surface that controls the fluid movement and location by wettability boundaries such as illustrated in FIGS. 2 and 3.

In the closed geometry as discussed above satellite or reagent positions are radially positioned about a center guide circle 78 where the specimen drop is deposited. The reagents can be fluid drops or dried spots. The reagent positions may be distributed as shown in FIGS. 2 and 3. In the case of fluid reagent drops, filler holes will be located above each reagent position. An alternative embodiment of the reagents are pads 76 as shown in FIGS. 4 and 5.

As mentioned above surface wettability can be homogeneous or patterned. A homogeneous surface is used for the spontaneous spreading of the sample drop (and satellite drops if they are used) to cause the contact. The spreading depends on the fluid surface tension, viscosity and the contact angle and contact angle hysteresis of the surface. The mixing zone is a result of this spreading. This option is the simplest to employ but provides less control of the formation of the mixing than a patterned surface. A patterned surface uses wettability boundaries to pin the final locations of the contact lines, leaving an gap of definable size in the boundaries to allow mixing of the two drops or spatially limited contact of the drop with a pad or dried spot of reagent. The contact angle range that can be maintained at the wettability boundary depends on the chemistry employed. This patterned option provides better control of the mixing zone and prevention of crosstalk.

As mentioned above the reagent can be a fluid drop, a dried spot, or in a porous pad. The need to confine the mixing zone to a subsection of the satellite region will favor a wet drop. It is more difficult to control the mixing zone to be only over a small section of the pad. In fact, one is most likely to design the pad so it is fully saturated with the sample at the end of the fluid flow as the sample is filled. A similar logic follows for dried spot. Thus if a mixing zone is to be limited to only a subsection of the satellite area, it is preferred to use a wet drop. Dried spots and pads are preferred for robustness to use in more uncontrolled environments because the ability to hold satellite drops in fixed positions, such as is required by a wet drop, may be susceptible to tilts of the sample, vibrations, etc.

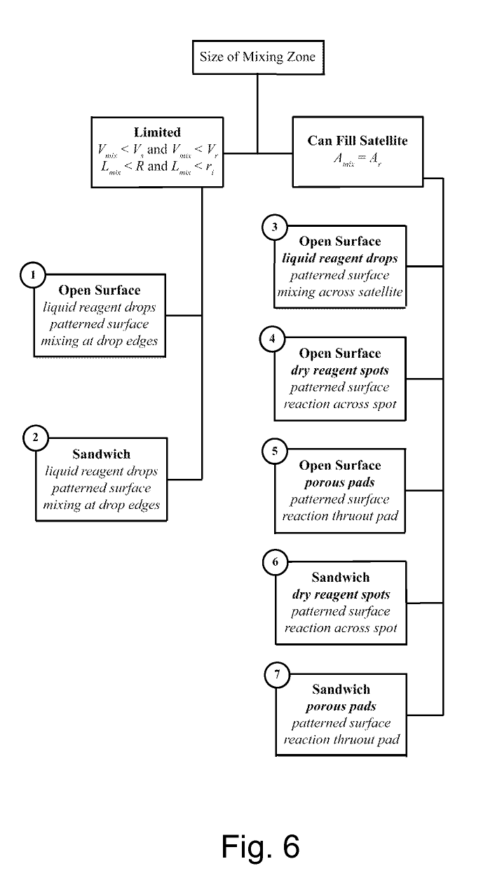

Now turning to FIG. 6 that illustrate seven possible embodiments of the present embodiment. Other possible embodiments are contemplated within the scope of the invention (such as homogenous surfaces), and invention is not to be limited to the illustrated embodiment. The embodiment selection process in FIG. 6 begins with the first question to determine the size of the mixing zone. If the mixing zone is to be a limited mixing zone (i.e. where the size of the mixing zone is smaller than either the sample drop or the reagent drop), then liquid reagent drops must be used with a patterned surface in the open or closed geometry, illustrated as embodiments 1 and 2 of FIG. 6. If the mixing zone is not limited or the goal is to achieve mixing across the entire satellite or reagent, but not the sample or specimen drop, then five (5) embodiments can be formed with liquid reagent drops, dry reagent spots or impregnated porous reagent pads with a patterned surface in the open or closed geometry), illustrated as embodiments 3-7 of FIG. 6.

The closed surface or sandwich geometry would be selected if one or more of several conditions applied:

1. The sample or reagent liquids evaporate on the order of a few seconds, which is a rough timescale for spreading, coalescence, and mixing;

2. The environment in which the device will be used is likely to have vibrations or impulses with large amplitudes that cause the drops to move across wettability boundaries;

3. The reagents could degrade (via oxidation or photodegradation) or become contaminated before the test could begin (i.e. in long term storage) or during the test (see item 1, around a few seconds);

4. The device will be used by an unskilled technician and therefore the demands on precise control over sample deposition need to be reduced;

5. More tests are needed than can fit around a sample drop in an open geometry (see more about this below); and

6. Surface tension differences (Marangoni stresses) between feasible solvents and sample liquid are too high to use an open geometry with liquid satellite drops and maintain control of the mixing zone

The dry reagent spots would be selected if one or more of several conditions applied:

1. A limited mixing zone was not required;

2. The method of readout required a larger area coverage (spatial resolution not good enough to be compatible with a very limited mixing zone);

3. Solution-based (liquid) testing was not feasible due to chemistry of the test desired, lack of solubility of reagents in viable solvents, fast evaporation;

4. The test desired required multiple reaction steps, rinsing steps or other more complex process steps;

5. The environment in which the device will be used is likely to have vibrations or impulses with large amplitudes;

6. The reagents could degrade (via oxidation or photodegradation) or become contaminated before the test could begin (i.e. in long term storage) or during the test (see item 1, around a few seconds);

7. The device will be used by an unskilled technician and therefore the demands on precise control over sample deposition need to be reduced;

8. More tests are needed than are feasible with liquid satellite drops, which have a specific practical range of sizes; and/or

9. Surface tension differences (Marangoni stresses) between feasible solvents and sample liquid are too high to use an open geometry with liquid satellite drops and maintain control of the mixing zone.

The impregnated porous pads would be selected if one or more of several conditions applied:

1. A limited mixing zone was not required;

2. The method of readout required a larger area coverage (spatial resolution not good enough to be compatible with a very limited mixing zone);

3. Solution-based (liquid) testing was not feasible due to chemistry of the test desired, lack of solubility of reagents in viable solvents, or fast evaporation;

4. Grafting molecules to a surface was not feasible due to chemistry of the test desired, or lack of ability to graft to a surface;

5. The test desired does not require multiple reaction steps, rinsing steps or other more complex process steps;

6. The environment in which the device will be used is likely to have vibrations or impulses with large amplitudes;

7. The reagents could degrade (via oxidation or photodegradation) or become contaminated before the test could begin (i.e. in long term storage) or during the test (see item 1, around a few seconds);

8. The device will be used by an unskilled technician and therefore the demands on precise control over sample deposition need to be reduced;

9. More tests are needed than are feasible with liquid satellite drops, which have a specific practical range of sizes; and/or

10. Surface tension differences (Marangoni stresses) between feasible solvents and sample liquid are too high to use an open geometry with liquid satellite drops and maintain control of the mixing zone.

The methods to manufacture the above-mentioned embodiments are as follows.

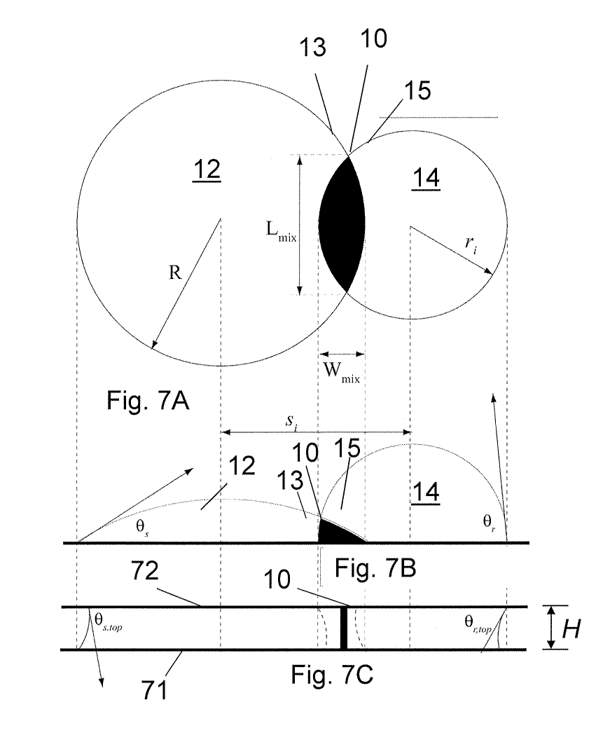

Now turning to FIGS. 7A and 7B for an illustration of the mixing zone 10 for Embodiment 1 diagnostic device in FIG. 6. Embodiment 1 diagnostic device has a limited mixing zone 10 (shown in black on FIGS. 7A and 7B) having a volume smaller than either the volume of sample or specimen drop 12 or the reagent drop 14. The limited mixing is achieved by employing a wettability patterned on the surface to control the location and size of the mixing zone for a wide range of materials and liquids. Mixing would occur at the drop edges 13, 15. Embodiment 1 uses an open surface configuration.

The first step in the method to design an Embodiment 1 diagnostic device is to take into consideration a given a sample or specimen, a desired number of tests N, and the desired reagent liquids for each test. Then the fluid properties are selected as indicated by the specific desired test or assay. These include surface tension σ, viscosity μ, and density ρ of each liquid (the sample and each of the N test reagents). Surface tensions are typically between 0.02 to 0.07 N/m. Viscosities for liquids of interest in multiplexed testing applications range from 0.001 to 1 Pa s (i.e. from water to a polymer solution). Densities will typically be on the order of 1000 kg/m³, similar to that of water or polymer solutions.

The second step in the method to design an Embodiment 1 diagnostic device is to take into consideration the volume Vₛ of the sample or specimen. This will be partially dictated by how much is available in a given application. Volumes are not likely to be larger than 20 μL or smaller than 1 nL.

Next the radii of the sample drop Rₛ and the satellite drops rᵢ depend on the volumes used, and the contact angles of the liquid on the surface. One embodiment of the radii ranges from about 100 μm to about 1 mm in order to keep the Bond number low (Bo=μgR²/σ≈1 for a nearly spherical cap shape). This minimizes the sample volume Vₛ as much as possible and enables smooth spreading behavior.

The next step in the method is to choose contact angles in the satellites or reagents and in the sample or specimen drop region. For example, choose the advancing static contact angle on a flat surface of the relevant surface-liquid pair. Contact angles can be varied between about 0° and 110° for flat surfaces. Contact angles can be varied independently in each region (sample and each satellite) using masking.

The next step is to choose the center-to-center spacing sᵢ between the sample drop and each satellite or reagent drop. The smallest possible value of sᵢ is the larger of Rₛ and rᵢ. The largest possible value of sᵢ is (Rₛ+rᵢ+extra distance). The extra distance, for example 10 μm, is allowed since surfaces will fluctuate a little and allow for coalescence even if the two drops nominally do not align. In addition, the extra distance allows the two drops to coalesce by touching above the contact line if the contact angle is larger than 90°.

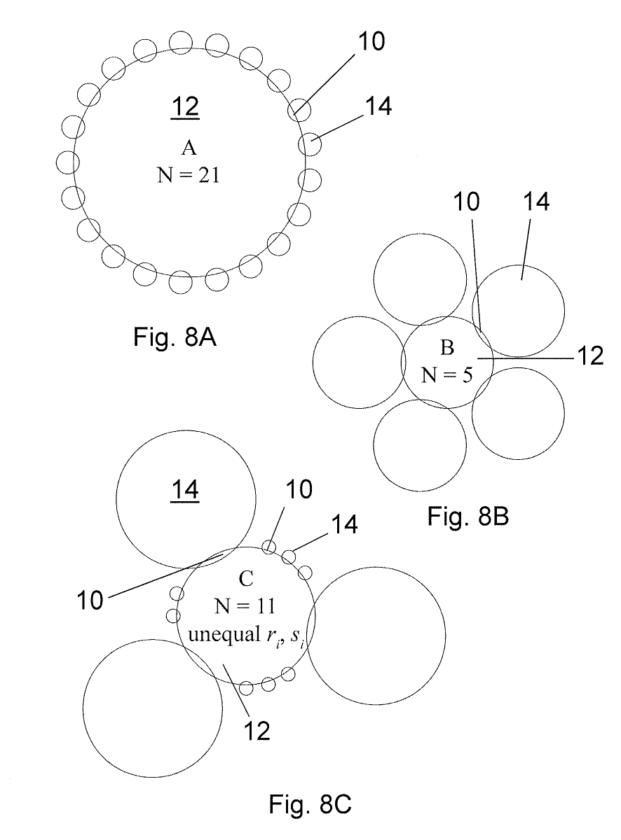

The next step is to choose the number of tests, which is limited by the practical range of specimen and reagent drop sizes and center-to-center spacings. The smallest number of tests (reagents) possible is N=1. The minimum angle αᵢ between each satellite or reagent placed around the circumference of the sample or specimen drop is given by the formula: αᵢ=2 sin⁻¹ ((rᵢ+ε)/sᵢ) where ε is a small distance needed to ensure no contact between the satellite or reagent drops. A minimum distance of ε≈50 μm should be used. If all satellite or reagent drop dimensions are equal, then the maximum number of tests possible is given by the formula: Nₘₐₓ=floor {360°/αᵢ}, where floor means the number rounded to the next lowest integer. If satellite or reagent drops have unequal sizes and center-to-center spacings then αᵢ should be calculated for each satellite or reagent drop and the sum of the angles should be less than 360°. Examples of three configurations A-C are shown to scale in FIGS. 8A-C.

Now turning to FIG. 8A illustrating Configuration A. If all rᵢ=100 μm, Rₛ=1000 μm, and all sᵢ=1050 μm (within the allowable limits of 1000 μm≦sᵢ≦1110 μm), then Nₘₐₓ=21.

Now turning to FIG. 8B illustrating Configuration B: If all rᵢ=1000 μm, Rₛ=1000 μm, and all sᵢ=1900 μm (within the allowable limits of 1000 μm≦sᵢ≦2010 μm), then Nₘₐₓ=5.

Now turning to FIG. 8C illustrating Configuration C: For three satellites or reagents with rᵢ=1000 μm, sᵢ=1900 μm and Rₛ=1000 μm, then 8 additional satellites or reagents with rᵢ=100 μm, sᵢ=1050 μm can fit.

The next step is selection of the volumes, radii, center-to-center distances, and contact angles of each of the sample and satellite drops. The size of the mixing zone is a function of all of these variables and needs to be designed to prevent net flow in or out of the sample/satellites by adjusting Laplace pressures in the drops and Marangoni stresses.

Now turning to FIG. 7C for an illustration of the mixing zone 10 for Embodiment 2 in FIG. 6. A limited mixing zone 10 is required (volume of mixing zone smaller than either the sample or the reagent drops). Liquid reagent drops are the only way to achieve limited mixing. Patterned surfaces on the bottom substrate 71 and/or top substrate 72 can be used to control the location and size of the mixing zone 10 for a wide range of materials and liquids. Mixing would occur at the drop edges.

The first step in the method to design an Embodiment 2 diagnostic device is to take into consideration a given sample or specimen, a desired number of tests N, and the desired reagent liquids for each test, then the fluid properties are selected. These include surface tension σ, viscosity μ, and density ρ of each liquid (the sample and each of the N test reagents). Surface tensions are typically between 0.02 to 0.07 N/m. Viscosities for liquids of interest in multiplexed testing applications range from 0.001 to 1 Pa s (i.e. from water to a polymer solution). Densities will typically be on the order of 1000 kg/m³, similar to that of water or polymer solutions.

The next step is to choose H (gap between bottom substrate 71 and top substrate 72) to achieve proper capillarity for wicking the sample into the cell. H ranges from about 100 μm to about 1 mm.

The next step is to choose contact angles in the satellites and in the sample drop region, on both top and bottom surfaces, to promote capillary flow into the sandwich configuration, contact angles must be less than 90°. Contact angles can be varied independently in each region (sample and each satellite) using masking and variable exposure time to the UV light.

The next step is the radii of the sample or specimen drop Rₛ and the satellite or reagent drops rᵢ should be 500 μm or greater. Once H is chosen, the radius and volume are no longer independent of each other: Vₛ=πRₛ²H and Vᵣ=πrᵢ² H. The volume of the sample Vₛ will be partially dictated by how much is available for a given application. Volumes smaller than 1 nL will be difficult to inject. For a given volume, a smaller H leads to a larger drop radius, which will allow more tests to be conducted simultaneously.

The next step is to choose the center-to-center spacing sᵢ between the sample or specimen drop and each satellite or reagent drop. The smallest possible value of sᵢ is the larger of Rₛ and rᵢ. The largest possible value of sᵢ is (Rₛ+rᵢ+extra distance). The small extra distance, for example 10 μm, is allowed since surfaces will fluctuate a little and allow for coalescence even if the two drops nominally do not align. In addition, the extra distance allows the two drops to coalesce by touching above the contact line if the contact angle is greater than 90°.

The next step is determining the number of tests or reagents in this configuration, which is calculated the same way as for Embodiment #1 discussed above. In this case, larger sample radii are allowed but there is a larger minimum radius. For example, if a large sample volume of V=20 μL is used with a moderate H=500 μm and the minimum satellite radius rᵢ=500 μm, then Rₛ=3.6 mm. If the center-to-center spacing is chosen as sᵢ=4110 μm, within the allowable limits of 3600 μm≦sᵢ≦4110 μm, then Nₘₐₓ=23. Reducing the gap to the minimum H=100 μm allows Rₛ=8000 μm, and choosing sᵢ=8500 μm, within the allowable limits of 8000 μm≦sᵢ≦8510 μm, then Nₘₐₓ=48. Thus, the maximum number of tests for the sandwich configuration is 2-3 times larger than that allowed in the open configuration.

The next step is sizing the mixing zone. The length of the mixing zone Lₘᵢₓ is fixed by the length of the intersection of the sample drop circle and the reagent drop circle. The length of the mixing zone can be as small as zero and as large as twice the smaller of the radii of the sample and reagent drops. The width of the mixing zone if controlled purely by diffusion of reagent molecules is given by the formula: Wₘᵢₓ=\sqrt{Dt_{contact}} where D is the molecular diffusion coefficient of the reagent molecules, and t_{contact} is the time elapsed since the two drops contacted one another. This elapsed time can be controlled by the user and is determined in part by the readout method—for example one may wish to wait longer for a wider zone if the readout method has lower spatial resolution. Wₘᵢₓ can also be limited by removing solvent from the mixing zone by evaporation or imbibition into a porous substrate.

Embodiment #3 diagnostic device in FIG. 6 (structure not shown) is an open geometry device that provides for a mixing zone that encompasses the entire satellite or liquid reagent drop region (area of mixing zone equals the area of the reagent drop). Patterned wettability on the substrate can be used to control the location and size of the mixing zone for a wide range of materials and liquids. All process steps are be the same as discussed above except that the specific dimensions are chosen such that there is a net flow out of the sample or specimen drop and into the satellite or reagent drop.

Embodiment #4 diagnostic device in FIG. 6 (structure not shown) is an open geometry device that provides for a mixing zone that encompasses the entire satellite containing the dried reagent drop region (area of mixing zone equals the area of the reagent spot). Patterned wettability on the substrate can be used to control the location and size of the mixing zone for a wide range of materials and liquids. Most process steps are the same as discussed above except that the contact angle of the sample liquid on the grafted surface should be less than that on the sample surface so that there is a net flow out of the sample drop and into the satellite region. The sizes of the grafted satellite regions are limited by the readout resolution/sensitivity. The space between each satellite region should be large enough that leaking of the meniscus across the spaces between satellites does not occur.

Embodiment #5 diagnostic device in FIG. 6 (structure not shown) is an open geometry device that provides for a mixing zone that encompasses the entire satellite region where porous pads are used (typically consisting of porous paper with reagents impregnated within the pore space). Patterned surfaces can be used on the bottom substrate to control the location and size of the mixing zone for a wide range of materials and liquids. Most of the process steps are the same as discussed above except that the contact angle of the sample liquid on the pad surface should be less than 90° such that there is a net flow out of the sample drop and into the pad. The sizes of the pads are limited by the readout resolution/sensitivity and the ability to cut/manufacture small pieces of the pads. The shape does not have to be rectangular (as shown in FIG. 5) or circular (as shown in FIGS. 2, 3 and 8), but can be other shapes. The space between each satellite region or porous pad should be large enough that leaking of the meniscus between the satellites pads does not occur.

Embodiment #6 diagnostic device in FIG. 6 (structure not shown) is a closed or sandwich geometry device that provides for a mixing zone that encompasses the entire satellite region where dried reagent spots are used. The area of mixing zone equals the area of the reagent spot. One example of dried reagent spots is molecules chemically grafted onto the surface. Patterned surfaces can be used on the bottom substrate surface and/or top substrate surface to control the location and size of the mixing zone for a wide range of materials and liquids. Most process steps are the same as discussed above except that the contact angle of the sample liquid on the grafted surface should be less than that on the sample surface so that there is a net flow out of the sample drop and into the satellite region. The sizes of the grafted satellite regions are limited by the readout resolution/sensitivity. The space between each satellite region should be large enough that leaking of the meniscus between satellites does not occur.

Embodiment #7 diagnostic device in FIG. 6 (structure not shown) is a closed or sandwich geometry device that provides for a mixing zone that encompasses the entire satellite region where porous pads are used (typically consisting of porous paper with reagents impregnated within the pore space). Patterned surfaces can be used on the bottom substrate surface and/or top substrate surface to control the location and size of the mixing zone for a wide range of materials and liquids. Most of the process steps are the same as discussed above except that the contact angle of the sample liquid on the pad surface should be less than 90° such that there is a net flow out of the sample drop and into the pad. The sizes of the pads are limited by the readout resolution/sensitivity and the ability to cut/manufacture small pieces of the pads. The shape does not have to be rectangular (as shown in FIG. 5) or circular (as shown in FIGS. 2, 3, and 8), but can be other shapes. The space between each satellite region or porous pad should be large enough that leaking of the meniscus between satellites does not occur.

One method to manufacture an open surface embodiment is discussed below having the following dimension labels: R=radius of central drop; Q=radius of satellite drops (if not all the same use a subscript), S=center to center distance between satellite and central spot (if not all the same use a subscript).

1. First choose R, Q, and S. The criteria for choosing R, Q, and S that fix the size of the opening between the satellite spots and the central spot. The number of tests to be done in parallel dictates how many satellite spots are needed. As the number of tests increases the satellite spots increases the R must increase. These parameters along with the following variables control the coalescence process and thus the location and extent of the mixing zones as well as the prevention of crosstalk:

A. Surface tensions of the liquids (and the differences between them);

B Range of contact angles allowed at the wettability boundaries;

C. Wettability of the “internal”, more wetting portions of the pattern;

D. Contact angle of drops when they touch (which is in turn control by the volumes of the satellite drops and the dynamic contact angle of the spreading central drop); and

E Speed of the spreading central drop when it touches the satellite drops (which is in turn controlled by the viscosity, surface tension, and density of the fluid in the central drop and the dynamic contact angles of the sample fluid against the more wetting, internal surfaces.

2. Next choose the nonwetting surface chemistry for the unetched “external” areas on the surface and uniformly coat the surface with that chemistry.

3. Then fabricate the mask needed to produce the pattern.

4. Expose the surface to UV light through the mask (see surface preparation memo);

5. Place the piece of glass on a horizontal surface with the pattern layer facing up;

6. Deposit the reagent solutions at the satellite loci. Chose the volume so the optimal contact angle is present on the edge of the drop in the opening between the satellite and central internal areas

7. Deposit the central drop using a volume that produces the spreading rate and contact angle when the drop contacts the satellite drops which produces the desired mixing zone;

8. Perform readout at the appropriate stage of the coalescence process. If a limited mixing zone desired, readout must be done before diffusion causes complete mixing of the fluids. This diffusive mixing occurs on a much slower timescale than the coalescence process. If the diffusive mixing must be arrested to preserve a limited mixing zone long enough to perform the readout, the heat the surface slightly but uniformly to enhance solvent evaporation or use a porous surface so the solvent is drawn down into the porous surface with the patterned wettability (but still having the drop edges meet thus preserving option of the embodiment shown in FIG. 1A and not moving to embodiment shown in FIG. 1D.

An example of preparing an open surface embodiment is a follow

1. Pick up a new 2″×2″ glass;

2. Flush the glass with D.I. water and blow it to dry with Nitrogen gas;

3. Wipe the glass with Aquapel several times until the Aquapel liquid also beads up on the surface, which indicates the glass surface turns to be hydrophobic;

4. Make a mask on a copper sheet which has been cut with a pattern of center spot and 4 satellite spots;

5. Cover the Aquapel treated glass substrate with this copper sheet compactly with the pattern lay on the top of the glassware;

6. Expose this combination of setup to UV light for half an hour, after which the glass has the hydrophilic surface in the middle while the hydrophobic region encompassing the pattern;

7. Acid clean the piece of glass after peeling off the copper sheet for 25 min, followed by flushing with D.I water;

8. Place the piece of glass on a horizontal surface with the pattern layer facing up;

9. Deposit the different buffer solutions at the satellite loci (about 2-4 uL);

10. Eject a phenolphthalein drop in the center locus until it encounters all four satellite drops (around 10-30 uL);

11. This configuration will give us the final results having two satellites lit up and two unchanged;

One method to manufacture a closed surface or sandwich embodiment is discussed below. 1. First, choose the material for the top and bottom plates and prepare with surface chemistry to attain contact angles of the sample fluid with both plates so the fluid is drawn into the gap by capillary action. Contact angles of less than ninety degrees are required but the lower the contact angle the more rapid the filling will be. The materials may be the same or different.

2. Next, drill a hole in the center of the top plate large enough to fit the end of the pipette or other device used to feed the sample fluid onto the cell.

3. Clean the plates with cleaning method appropriate for the material and surface chemistry chosen. The choice of cleaning process is known art for many surfaces.

4. Adhere the porous pads with the reagent rich face toward the plate that is most wetting and through which the device will be read out. This is usually the bottom plate but need not be. Place the pads so they touch the “guide circle”. Choose the dimension of the guide circle so it is as small as it can be (to minimize the sample volume) but is large enough to allow the pads to have spacing between them large enough to prevent crosstalk in the tests. The gap between the pads must be greater than the meniscus that will form when each pad is saturated with the sample fluid after filling and flow has ceased. The area of the pads should be large enough to facilitate the readout mechanism. For simple optics this might be millimeter scale in size but much smaller sizes might be sufficient for more sophisticated optical readout or other types of readout. Do not make the pads larger than needed because then they will require more sample volume to fill the pore space and saturate the pad. The surface chemistry of the porous pad should be such that the sample fluid should wet the pore space of the pads well. The pads need not be rectangular as shown but could be shaped to allow more tests while keeping the guide circle as small as possible.

5. Choose the gap size to be used: The gap should be as small as possible to promote capillary filling of the cell and minimize the volume of sample need to fill cell enough to touch and wet each pad. One embodiment of the present invention includes gap values between 10 microns and 0.5 mm are acceptable. Another embodiment of the present invention includes gap values as large as 1 mm and as small as 1 micron. The optimal filling will occur when pads fill the gap and are the spacer to determine the gap. However, it is envisioned at times when a thicker gap may be desirable and that would be provided by thicker nonporous pads of material placed at locations in the gap under the clamps that hold the cell together.

6. Place the top plate on top of the pads, such that the pads are in between the top and bottom plates, making sure the filler hole in the top plate is in the center of the guide circle.

7. Clamp the plates together by some convenient mechanism such the clamp does not distort the plates causing a non-uniform gap between them.

8. Place the clamped cell on a flat surface.

9. Inject enough volume of the sample to just saturate the pore space of pads. The desired condition is that the fluid is drawn into the gap from the filler hope and then out of the central region of the gap (the region marked by the guide circle) into the pores of the paper which will pull the fluid out of the gap because of their smaller size than the gap.

10. Allow reactions to occur; and

11. Read out results

An example of the closed surface embodiment is as follows:

1. Obtain a glass microscope slide and a plate of acrylic glass of the same size;

2. Drill a hole in the center of the acrylic glass large enough to fit the end of a pipette through (approximately 1/16 inch diameter);

3. Clean the glass by using a type of acid cleaning;

4. Clean the acrylic glass by using a water spray, acetone spray and water spray;

5. Dry both the glass and acrylic glass while continuing to maintain the cleanliness;

6. Adhere the strips which test for ions (in this case 3 strips where used testing for Iron, Copper and Chloride Ions) with the reactant pads facing the glass and pointing radially inward toward the center of the glass;

7. Place the acrylic glass on top of the strips, such that the strips are in between the glass and the acrylic glass, making sure the hole in the acrylic glass is in the center and equidistant from the ends of the strips with the reactants;

8 Bind the two glasses together using removable clamps (in this case, binder clips);

9. Place the sandwich geometry on a flat surface with the acrylic glass on top;

10. Inject enough volume of the sample (approximately 50 micro liters) using a pipette through the hole in the acrylic glass such the sample comes in contact with each strip's reactant;

11. Allow reaction to occur;

12. Flip sandwich geometry over and compare the strips with the color codes on the strip packaging to determine if an ion is present in the sample and how much of the ion is present in the sample;

13. To repeat, take clamps off, remove used strips, and begin by cleaning the glass and acrylic glass again.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method of performing a diagnostic test, the method comprising:
providing a diagnostic testing device having a substantially flat top surface;
selecting the size and location of a mixing zone based on a fluid mechanic property of a sample liquid and a reagent to be used on the surface of the diagnostic testing device;
applying a wettability pattern on the top surface,
wherein the pattern comprises a sample drop portion and a reagent portion positioned near the sample drop portion,
wherein the pattern controls the location and size of the mixing zone formed between the sample drop portion and the reagent portion;
placing the sample liquid in the sample drop portion;
placing the reagent in the reagent portion;
allowing at least one of the sample liquid and the reagent to spread towards the mixing zone,
wherein the sample liquid and the reagent contact in the mixing zone;
reacting the reagent and the sample liquid only in the mixing zone.

2. The method of claim 1, wherein applying the wettability pattern on the top surface comprises:
applying a hydrophobic material to the top surface;
creating a mask, wherein the mask has open spaces that imitate the wettability pattern;
covering the top surface with the mask;
exposing the masked top surface to an energy source capable of degrading the hydrophobic material, thereby removing the hydrophobic material from the open spaces not covered by the mask.

3. The method of claim 1, wherein applying the wettability pattern on the top surface comprises:
roughening an area of the top surface corresponding to at least one of the sample drop portion and the reagent portion.

4. The method of claim 1, wherein applying the wettability pattern on the top surface comprises:
providing a porous medium in at least one of the sample drop portion and the reagent portion.

5. The method of claim 1, wherein the wettability pattern further comprises:
a second reagent portion positioned near the sample drop portion,
wherein the pattern controls the size and location of a second mixing zone formed between the second reagent portion and the sample drop portion.

6. The method of claim 5, wherein the wettability pattern further comprises a boundary separating the reagent portion and the second reagent portion.

7. The method of claim 5, further comprising:
placing a second reagent in the second reagent portion;
allowing at least one of the sample liquid and the second reagent to spread towards the second mixing zone,
wherein the sample liquid and the second reagent contact in the second mixing zone; and
reacting the second reagent and the sample liquid only in the second mixing zone.

8. The method of claim 8, wherein the reagent and the second reagent do not mix.

9. The method of claim 1, wherein applying the wettability pattern on the top surface comprises:
creating a microfabricated pattern on the top surface.

10. The method of claim 1, wherein the reagent is a liquid.

11. The method of claim 1, wherein applying the wettability pattern on the top surface comprises:
placing a porous pad within the reagent portion.

12. The method of claim 1, further comprising:
positioning a flat plate a distance above the top surface and substantially parallel with the top surface to form a substantially closed test chamber.

13. The method of claim 12:
wherein the flat plate has a hole sized to receive the sample liquid; and
wherein the sample liquid is placed on the sample drop portion through the hole.

14. The method of claim 1, wherein the mixing zone is comprised of a portion of the sample drop portion and a portion of the reagent portion.

15. The method of claim 1, wherein the mixing zone is comprised of a bridge extending between the sample drop portion and the reagent portion.

16. The method of claim 6, wherein the boundary has a lower wettability than the reagent portion or the second reagent portion.
